(19) United States
(12) Patent Application Publication
(10) Pub. No.: US 2019/0176580 A1
(43) Pub. Date: Jun. 13, 2019

(54) ROLLER BLIND ASSEMBLY FOR A VEHICLE BODY, AND METHOD FOR ASSEMBLING THE ROLLER BLIND ASSEMBLY

(71) Applicant: WEBASTO SE, Stockdorf (DE)

(72) Inventor: Erwin STEINER, Stockdorf (DE)

(73) Assignee: WEBASTO SE, Stockdorf (DE)

(21) Appl. No.: 16/310,853

(22) PCT Filed: Jun. 22, 2017
(86) PCT No.: PCT/EP2017/065391

§ 371 Date: Dec. 18, 2018

(30) Foreign Application Priority Data
Jun. 27, 2016 (EP) 10 2016 111 695.5

(51) Int. Cl. B60J 1/20

(52) U.S. Cl. CPC B60J 1/2063; B60J 1/2036

(57) ABSTRACT

A roller blind assembly to shade an opening in the vehicle body having a roller blind web which can be rolled up on a winding roller, and at least one support element for rotatably mounting the winding roller on the vehicle body. According to one approach the support element has a standardized section which is designed to be used with multiple different vehicle models, and a vehicle-specific section which is designed to be used with one specific model of the different vehicle models, so that the standardized section combined with the vehicle-specific section provides a vehicle-specific support element. A method for assembling such a roller blind assembly is provided.

This invention relates to a roller blind assembly according to the preamble of claim 1, and to a method for assembling the roller blind assembly and/or for installing the roller blind assembly on a vehicle body according to claim 8.

Roller blind assemblies for vehicle bodies are known from the prior art. They are used for shading an opening in the vehicle body, such as, for example, a roof opening, which is tightly closed with a transparent cover or which can be opened or closed as desired. Such known roller blind assemblies have a roller blind web which can be wound and unwound and which can be mounted in a wound position on a winding roller. At least one support element is provided, by means of which the winding roller is rotatably mounted on the vehicle body.

The disadvantage of such known roller blind assemblies for vehicle bodies is that fact that, for different vehicle models, in each case a vehicle-specific support element has to be provided, although only the positioning of the winding roller changes. Since the support elements are complex components, the tools necessary for their production are relatively expensive to produce and, together with the support element itself, have to be newly developed for each new vehicle model or also for different variants of a specific vehicle model. This leads to considerable costs and complex production logistics.

An aim of this invention therefore is to provide a roller blind assembly for a vehicle body and a method for assembling the roller blind assembly and/or for installing said roller blind assembly on a vehicle body, which prevent these problems of the prior art.

This aim is achieved by a roller blind assembly according to the features of claim 1 and by a method according to claim 8.

According to the invention, the support element has a standardized section which is designed to be used with multiple different vehicle models, and a vehicle-specific section which is designed to be used with one specific model of the different vehicle models. The standardized section together with the vehicle-specific section thus result in a vehicle-specific support element (which, however, can contain other components).

This offers the advantage that, for adaptation to a new vehicle model, only the vehicle-specific section has to be adapted, while the standardized section can be kept. The term “different vehicle models” can here also be merely an equipment variant of a vehicle with, for example, a different roof liner or a different size of an opening in the vehicle roof.

In a method for assembling the roller blind assembly in accordance with this invention or for installing such a roller blind assembly on a vehicle body, in the course of the method, a vehicle-specific section is selected in accordance with the specific vehicle model and is combined with a standardized section in order to obtain a vehicle-specific support element.

Advantageous designs of this invention result from the dependent claims.

In a preferred design of this invention, the vehicle specific section has a recess for mounting the winding roller, wherein the recess establishes the vehicle-specific positioning of the winding shaft relative to the vehicle body. The vehicle-specific positioning of the winding shaft relates in particular to the orientation of the winding shaft in a vertical direction as well as in the longitudinal direction of the vehicle. The vehicle-specific section thus establishes how the winding shaft and in particular how its rotation axis is arranged relative to the vehicle body. By subdividing the support element into a standardized section and a vehicle-specific section, this positioning of the winding shaft can thus be carried out without the whole support element having to be newly developed and produced for an additional vehicle model.

Preferably, the recess for mounting the winding roller has a bearing pin. Said bearing pin engages in an opening on the end side of the winding shaft, wherein the winding shaft is rotatably mounted on the bearing pin or together with said bearing pin.

In another advantageous design of this invention, the standardized section is arranged on a guide rail for the lateral guiding of the roller blind web. Such lateral guide rails are used for guiding the roller blind web in its side areas and for applying mechanical tension to it, in order to prevent the roller blind web from sagging in the unwound state. The vehicle-specific section is here arranged on the standardized section on a side of the standardized section facing away from the guide rail in horizontal direction.

In an alternative design of this invention, the standardized section is arranged on a frame side part of a rectangular frame of the roller blind web. Such frames can be provided in order to at least partially surround an opening in the vehicle body. Like the above-mentioned guide rail, such a frame can be part of a complete roof module also comprising, in addition to the roller blind assembly, a transparent cover for closing the opening in the vehicle body. A corresponding roof module can be put completely pre-assembled with a firmly positioned or displaceable cover onto the area of, for example, a roof opening in a vehicle roof.

If, in the roller blind assembly, a roller blind web is provided with a winding roller, then the corresponding roller blind assembly preferably has two support elements which rotatably mount the winding roller on two round end sides in side areas of the winding roller. In roller blind assemblies with more than one winding roller, a pair of support elements is associated preferably correspondingly with each winding roller.

Preferably, the standardized section and the vehicle-specific section consist substantially of an injection molded part and are molded preferably from a plastic.

In a particularly preferred design of the inventive method, the vehicle-specific section has a recess for mounting the winding shaft, and the vehicle-specific positioning of the winding shaft relative to the vehicle body is established by the selection of the vehicle-specific section in accordance with a specific vehicle model.

Preferably, the vehicle-specific section is first combined with the standardized section, wherein the two sections can also be combined with additional components, in order to produce a vehicle-specific support element. This vehicle-specific support element is then installed on a guide rail or on a frame portion of the roller blind assembly (or of a roof module which contains the roller blind assembly). A corresponding roller blind assembly can thus be delivered pre-assembled to a vehicle manufacturer and is already adapted to the designated vehicle model, without the whole support element having to be produced, for example, injection molded, already as a vehicle-specific support element, since, as already mentioned, each vehicle-specific support element is constructed from a standardized section and a vehicle-specific section.

Below, the invention is explained in further detail as an example in reference to the appended figures. In the figures:

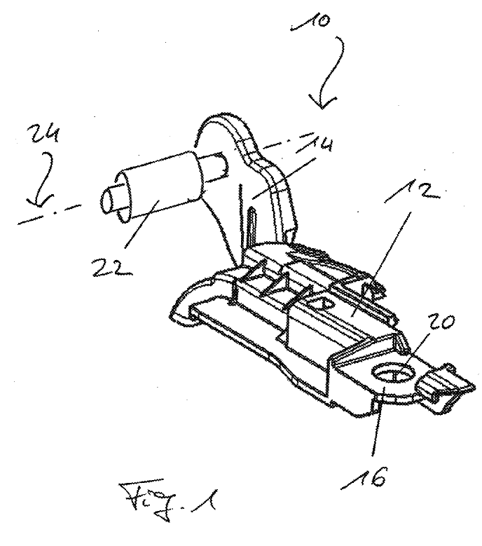

FIG. 1 shows a perspective view of an inventive support element;

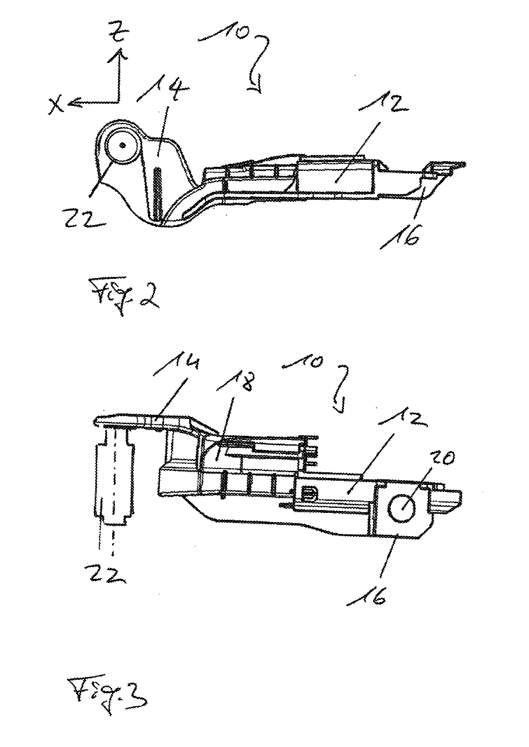

FIG. 2 shows a side view on the support element of FIG. 1; and

FIG. 3 shows a view from the top onto the support element of FIG. 1.

FIG. 1 shows a support element 10 according to this invention.

The support element 10 is used for mounting a winding roller, not shown in further detail, wherefore the support element 10 has a bearing pin 22 which is rotatably arranged on the support element 10 and designed to engage in a winding roller in order to rotatably mount said winding roller. Here, the bearing pin 22 can engage in a corresponding opening in an end surface of the winding roller, and the bearing pin 22 is oriented substantially along the rotation axis 24 of the winding roller, wherein the rotation axis of the winding roller runs through a center axis of the bearing pin.

According to this invention, the support element 10 has a standardized section 12 which is connected to a vehicle-specific section 14. By means of the standardized section 12, the support element 10 can be arranged on a guide rail, not shown, or a frame, also not shown. For this purpose, the standardized section 12 has a connection section 16, in which an opening 20 is provided in order to produce a screw connection or a rivet connection with the guide rail or the frame side part. Both the standardized section 12 and the vehicle-specific section 14 of the support element 10 are designed as injection molded parts, preferably as plastic injection-molded parts. The frame side part or the guide rail, on which the support element 10 is fastened via the connection section 16, is arranged along a side area of an opening in a vehicle body. In the mounted state, the support element 10 has a winding roller on which a roller blind web is wound and from which it can be unwound in order to shade an opening in the vehicle body, wherein the opening is preferably tightly closed with a transparent cover, or, in an embodiment, it is designed so that it can be opened or closed as desired with a displaceable cover.

FIGS. 2 and 3 show the support element 10 of FIG. 1. in a side view and in a view from the top. According to this invention, the standardized section 12 of the support element 10 and the vehicle-specific section 14 are connected to one another in a connection area 18 (see view from the top of FIG. 3). The support element 10 is thus designed to have at least two parts and thus preferably it comprises further parts, such as the bearing pin 22 which is rotatably mounted on as separate component in the vehicle-specific section 14 of the support element 10.

In the side view of FIG. 2, a longitudinal direction of the vehicle is marked with the direction arrow x, and a vertical direction (perpendicular to the vehicle roof) is marked with the direction arrow z. In the represented embodiment, a roller blind web, not shown, is unwound from the winding shaft against the travel direction x towards the rear. Depending on the vehicle model or equipment variant of a specific vehicle model, there is an optimal position here for the winding roller and thus for the bearing pin 22 in the x direction and in the y direction. The positioning in the z direction occurs here taking into consideration the existing installation space of the installation of the roller blind assembly in the vehicle body, wherein, for example, in order to increase the headroom, the bearing pin 22 is arranged to be shifted as far as possible upward in the z direction, so that the available installation space is optimally used. The positioning of the bearing pin 22 in the x direction is selected in such a manner that an optimal distance relative to the lateral guide rail of the roller blind assembly is achieved. Because of these requirements, for each vehicle model, a specific positioning of the bearing pin 22 in the z direction and the x direction has to be carried out. In order to avoid having to develop and produce a whole support element 10 (and with it the corresponding molding tools) for each different vehicle model, the standardized section 12 of the support element 10 is designed so that it can be used for different vehicle models, while the exact positioning in the x direction and in the z direction of the bearing pin 22 is achieved by the vehicle-specific section 14. Since the vehicle-specific section 14 of the support element 10 is considerably less complex than the whole support element 10, this leads to a considerable cost reduction, since, for the adaptation to a different vehicle model, only the vehicle-specific section 14 has to be changed. The vehicle-specific section 14 of the support element 10 is thus used as an adaptive element of the support element 10.

As already explained, the standardized section 12 of the support element 10 and the vehicle-specific section 14 are connected to one another in the connection area 18. The connection can here be produced by a catch mechanism, screw connection, riveting or gluing.

In the assembly of the roller blind assembly, the standardized section 12 can first be connected to the vehicle-specific section 14, and only in the connected state can be arranged on a frame side part or on a guide rail of the roller blind assembly. Alternatively, the standardized section can also first be arranged on the guide rail or on the frame side part, and, at a later time, the vehicle-specific section 14 together with the bearing pin 22 and optionally even with the already stuck-on winding roller together with the roller blind web can be arranged on the standardized section 12 of the support element 10. In principle it would also be possible that the vehicle-specific section 14, together with the winding roller arranged on the bearing pin 22 and with the roller blind web, is subsequently fastened on a standardized section which is already installed on the vehicle.

### LIST OF REFERENCE NUMERALS

10 Support element
12 Standardized section of 10
14 Vehicle-specific section of 10
16 Connection section
18 Connection area
20 Opening
22 Bearing pin
24 Rotation axis

1. A roller blind assembly to shade an opening in a vehicle body comprising:
a roller blind web which can be rolled up on a winding roller,
as well as at least one support element for rotatably mounting the winding roller on the vehicle body,
the support element comprising a standardized section which is designed to be used with multiple different vehicle models, and
a vehicle-specific section which is configured for with one specific model of different vehicle models.

2. The roller blind assembly according to claim 1, wherein the vehicle-specific section has a recess for mounting the winding roller, and wherein the recess establishes the vehicle-specific positioning of the winding shaft relative to the vehicle body.

3. The roller blind assembly according to claim 2, wherein the recess for mounting the winding roller has a bearing pin which engages in an opening on an end side of the winding shaft, and the winding shaft is rotatably mounted on the bearing pin or together with said bearing pin.

4. The roller blind assembly according to claim 1, wherein the standardized section is arranged on a guide rail for lateral guiding of the roller blind web, and the vehicle-specific section is arranged on a side of the standardized section facing away from the guide rail in a horizontal direction.

5. The roller blind assembly according to claim 1 wherein the standardized section is arranged on a frame side part of a rectangular frame of the roller blind assembly,
wherein the frame is provided in order to surround at least partially an opening in the vehicle body, and
wherein the vehicle-specific section is arranged on the standardized section on a side of the standardized section facing away from the frame side part in a horizontal direction.

6. The roller blind assembly according to claim 1, wherein the roller blind assembly has two support elements.

7. The roller blind assembly according to claim 1, wherein the standardized and/or the vehicle-specific section comprises a plastic injection molded part.

8. The roller blind assembly according to claim 1, wherein the support element is designed in at least two parts, with the standardized section as a first part and the vehicle-specific section as a second part.

9. The roller blind assembly according to claim 8, wherein the standardized section and the vehicle-specific section are connected to one another in a connection area.

10. A method for the assembly of a roller blind assembly according to claim 1 and/or for the installation of such a roller blind assembly on a vehicle body, comprising the step of:
selecting the vehicle-specific section in accordance with the specific vehicle model, and
combining the vehicle-specific section with the standardized section.

11. The method according to claim 10, wherein the vehicle-specific section has a recess for mounting the winding roller, and by the selection of the vehicle-specific section in accordance with the specific vehicle model, the vehicle-specific positioning of the winding shaft is established relative to the vehicle body.

12. The method according to claim 10, wherein the step of combining the vehicle-specific section with the standardized section is to obtain a vehicle-specific support element, and later further comprising mounting the support element on a guide rail or on a frame side part of the roller blind assembly.
